(19) United States
(12) Patent Application Publication
(10) Pub. No.: US 2012/0285612 A1
(43) Pub. Date: Nov. 15, 2012

(54) DELAYED ACTION POLYURETHANE CATALYST

(76) Inventor: Stephen Burks, Essexville, MI (US)

(21) Appl. No.: 13/519,149

(22) PCT Filed: Jan. 26, 2011
(86) PCT No.: PCT/US2011/022485

§ 371 Date: Jun. 26, 2012

Related U.S. Application Data
(60) Provisional application No. 61/298,821, filed on Jan. 27, 2010.

(51) Int. Cl. C08G 18/20; C08L 75/08; B32B 37/14; C08F 4/00

(52) U.S. Cl. 156/242; 502/167; 528/54; 524/871

(57) ABSTRACT

A mixture of a 1,2,4-triazole-blocked 1,8-diazabicyclo-5.4.0-undecene-7 and a phthalic acid-blocked 1,8-diazabi-cyclo-5.4.0-undecene-7 in a weight ratio of from 5:95 to about 30:70 is a useful polyurethane polymerization catalyst. The catalyst mixture is especially useful in applications in which long open times are needed at temperatures up to about 40° C., to be followed by a fast high temperature cure.

This application claims priority from U.S. Provisional Application No. 61/298,821, filed 27 Jan. 2010.

This invention relates to a delayed action catalyst for polyurethane formulations.

Polyurethanes are produced industrially in a reaction of a polyisocyanate with polyol or polyamine compounds. The reactions are almost always catalyzed to provide cure times that are short enough for the manufacturing process to be economically feasible.

Some manufacturing processes require a delayed cure. For example, some manufacturing processes require that a polyurethane-forming mixture to be prepared and then applied to some other material before it is cured. Some “working time”, which may be up to several minutes in some processes, may be needed to apply the mixture and to manipulate it further, before the mixture builds a high molecular weight and becomes too viscous to work with. Examples of processes like this include cushion-backed textile manufacturing, automotive windshield installation and the manufacture of certain types of reinforced composites such as automotive headliners. In all of these processes, some delay in the initial cure is wanted, to provide enough time that the polyurethane-forming mixture can be applied and manipulated. However, after some predetermined “working time”, it is usually desirable that the reaction mixture cures rapidly. The rapid cure allows manufacturing equipment to handle greater volumes of product per unit time and thus allows for increased production rates and lower manufacturing costs.

Previous efforts to provide a delayed cure have focused on the selection of the catalyst. Various types of delayed action catalysts are known. Some are simply relatively inactive catalysts, and the delayed action is mainly an artifact of a generally slow cure. These catalysts can provide for good working time, but the slow cure means that line processing speeds are slow and/or in-mold residence times are long, and for that reason these catalysts are often not useful in commercial processes.

Other delayed catalysts are heat-activated types. Among these types are encapsulated catalysts, in which the active catalytic material is embedded in or encapsulated in a thermally sensitive material that melts or thermally degrades at a predetermined temperature. These materials can provide both delayed action and a fast cure (upon becoming activated), but the activation temperature is usually far above ambient temperature. Thus, catalysts of this type may be useful if the polyurethane system is to be heated to, for example, 60° C. or more, but they do not function as well if catalytic activity is needed at a lower temperature, and often do not provide fast enough cures when mold temperature is below about 80° C.

Another type of delayed action catalyst is a blocked catalyst. These catalysts are most typically tertiary amines which are blocked with a compound such as an organic acid, although some blocked organotin catalysts also are known. Various blocked amine catalysts are commercially available, including carboxylic acid-blocked triethylene diamine, bis(dimethylaminoethyl)ether and 1,8-diazabicyclo-5.4.0-undecene-7 (DBU) catalysts. DBU catalysts blocked with 2-ethylhexanoic acid, 1,2,4-triazole and phthalic acid (1,2-benzenedicarboxylic acid) are all commercially available. In addition, amine-blocked tin (IV) compounds, such as those described in U.S. Pat. No. 5,491,174 are also available commercially.

Some processes require a long open time at temperatures that might reach as much as about 40° C. These temperatures are sometimes encountered during summer months in manufacturing facilities that are not climate-controlled. The starting materials in such cases are usually maintained at ambient temperature, and therefore are already warm when they are brought together to form a polyurethane-forming reaction mixture. In these processes, a desirable catalyst system should provide for a long working time even at temperatures of up to 40° C., and then provide for a rapid cure. Certain automotive headliner manufacturing processes in particular would benefit from such a catalyst system.

This invention is in one aspect a polyurethane catalyst system comprising a mixture of a 1,2,4-triazole-blocked 1,8-diazabicyclo-5.4.0-undecene-7 and a phthalic acid-blocked 1,8-diazabicyclo-5.4.0-undecene-7 in a weight ratio of from 5:95 to about 30:70.

The invention is also a process for preparing a polyurethane and/or polyurea polymer, comprising mixing at least one isocyanate-reactive compound with at least one organic polyisocyanate at a temperature of 40° C. or less, in the presence a mixture of a 1,2,4-triazole-blocked 1,8-diazabicyclo-5.4.0-undecene-7 and a phthalic acid-blocked 1,8-diazabicyclo-5.4.0-undecene-7 in a weight ratio of from 5:95 to about 30:70, and then heating the resulting mixture to a temperature of at least 60° C. to cure the mixture and form a polyurethane and/or polyurea polymer.

In an aspect of particular interest, the invention is a process for preparing a fiber-reinforced polyurethane, comprising,

a) applying a polyurethane-forming composition to at least one reinforcing fiber to form an impregnated, fiber-reinforced mat, and

b) molding the impregnated, fiber-reinforced mat at an elevated temperature sufficient to cure the polyurethane-forming composition, to form a molded, fiber-reinforced polyurethane,

wherein the polyurethane-forming composition includes a polyol or mixture of polyols, an organic polyisocyanate, and a catalyst, wherein the catalyst is a mixture of a 1,2,4-triazole-blocked 1,8-diazabicyclo-5.4.0-undecene-7 and a phthalic acid-blocked 1,8-diazabicyclo-5.4.0-undecene-7 in a weight ratio of from 5:95 to about 30:70. Step a) of this process may be performed by

a-1) impregnating a cellular polymer with the polyurethane-forming composition,

a-2) applying a reinforcing fiber to at least one side of the impregnated cellular polymer to form the impregnated, reinforced mat.

An adhesive film, show surface, reinforcing scrim or other covering layer may be applied to either or both sides of the impregnated, reinforced mat prior to the molding step b), or after that step.

The molded, fiber reinforced polyurethane in some embodiments forms all or a portion of an automotive headliner.

The catalyst of the invention is a mixture of a 1,2,4-triazole-blocked 1,8-diazabicyclo-5.4.0-undecene-7 and a phthalic acid-blocked 1,8-diazabicyclo-5.4.0-undecene-7 in a weight ratio of from 5:95 to about 30:70. 1,8-diazabicyclo-5.4.0-undecene-7 (DBU) and 1,2,4-triazole have structures I and II, respectively:

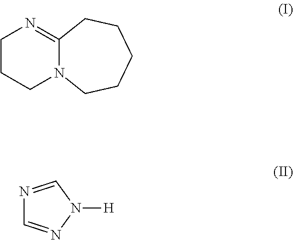

A 1,2,4-triazole-blocked DBU may contain DBU and 1,2,4-triazole in a molar ratio of about 0.5:1 to about 1.5:1, preferably from about 0.8:1 to about 1.1:1. The 1,2,4-triazole-blocked DBU may be dissolved or dispersed in a solvent or diluent. The solvent or diluent may be an isocyanate-reactive material such as an alkylene glycol or a polyalkylene glycol. A commercially available 1,2,4-triazole-blocked DBU catalyst is sold by Tosoh Chemical Corporation under the tradename Toyocat™ DB30 catalyst. This commercial material is believed to contain about 48% active catalyst by weight.

A phthalic acid-blocked DBU may contain DBU and phthalic acid in a molar ratio of about 0.5:1 to about 1.5:1, preferably from about 0.8:1 to about 1.1:1. The phthalic acid-blocked DBU may be dissolved or dispersed in a solvent or diluent. The solvent or diluent may be an isocyanate-reactive material such as an alkylene glycol or a polyalkylene glycol. A commercially available phthalic acid-blocked DBU catalyst is sold by Tosoh Chemical Corporation under the tradename Toyocat™ DB60 catalyst. The commercial material is believed to contain about 42% by weight active catalyst.

The 1,2,4-triazole-blocked DBU catalyst and the phthalic acid-blocked DBU catalyst are used in a weight ratio of from 5:95 to 30:70. A preferred ratio is from 10:90 to 30:70 and a more preferred ratio is from 15:85 to 25:75, again by weight. The weight of any solvent or carrier for the active catalyst is disregarded in determining these ratios.

Polyurethane and/or polyurea polymers are made in accordance with the invention by reacting at least one isocyanate-reactive compound with at least one polyisocyanate, in the presence of the catalyst mixture described above. In some embodiments, the catalyst mixture is the only catalyst present during the reaction although tertiary amine-containing polyols, which are often autocatalytic, may be present in the system. In other embodiments, one or more additional catalysts may be present. When making a composite in accordance with the invention, and in particular when making an automotive headliner in accordance with the invention, it is preferred that no other catalysts are present, although one or more tertiary amine-containing polyols may be present in such a case.

The isocyanate-reactive compound can be any organic compound, polymer or mixture of compounds and/or polymers that contain two or more hydroxyl, primary amino and/or secondary amino groups per molecule. Hydroxyl groups are preferably aliphatic (including cycloaliphatic) and can be primary or secondary. Amino groups, when present, may be aliphatic or aromatic. The isocyanate-reactive compound(s) may contain, for example, from 2 to 16 hydroxyl, primary amino and/or secondary amino groups per molecule. For most applications, the isocyanate-reactive compound will contain from 2 to 8 or from 2 to 4 of these reactive groups per molecule. The isocyanate-reactive compounds may have equivalent weights of from about 30 to about 10,000 per isocyanate-reactive group. The number of isocyanate-reactive groups per molecule and the equivalent weight are generally selected with attributes that are needed in the particular polyurethane product in mind. Mixtures of isocyanate-reactive compounds are often used in particular applications.

Suitable isocyanate-reactive compounds include polyether polyols, which are conveniently made by polymerizing an alkylene oxide onto an initiator compound (or mixture of initiator compounds) that has multiple active hydrogen atoms. The nominal functionality of the polyol is in most cases determined by the number of active hydrogen atoms on the initiator compound or compounds. Therefore, a suitable initiator compound (or mixture of compounds) has an average functionality within the ranges described above with respect to the polyol compounds. The initiator compound(s) may include alkylene glycols (e.g., ethylene glycol, propylene glycol, 1,4-butane diol, 1,6-hexanediol and the like), glycol ethers (such as diethylene glycol, triethylene glycol, dipropylene glycol, tripropylene glycol and the like), glycerine, trimethylolpropane, pentaerythritol, sucrose, glucose, fructose or other sugars, and the like. An initiator compound may contain primary and/or secondary amino groups, such as o-toluene diamine, ethylene diamine, diethanolamine, monoethanolamine, piperazine, aminoethylpiperazine, diisopropanolamine, monoisopropanolamine, methanolamine, dimethanolamine and the like.

The alkylene oxide may be, for example, ethylene oxide, propylene oxide, butylene oxide, tetramethylene oxide or other polymerizable cyclic ether. Propylene oxide and mixtures of propylene oxide with ethylene oxide are generally preferred.

Polyester polyols may also be used as all or part of the isocyanate-reactive compound. The polyester polyols include reaction products of polyols, preferably diols, with polycarboxylic acids or their anhydrides, preferably dicarboxylic acids or dicarboxylic acid anhydrides. The polycarboxylic acids or anhydrides may be aliphatic, cycloaliphatic, aromatic and/or heterocyclic and may be substituted, such as with halogen atoms. The polycarboxylic acids may be unsaturated. Examples of these polycarboxylic acids include succinic acid, adipic acid, terephthalic acid, isophthalic acid, trimellitic anhydride, phthalic anhydride, maleic acid, maleic acid anhydride and fumaric acid. The polyols used in making the polyester polyols include ethylene glycol, 1,2- and 1,3-propylene glycol, 1,4- and 2,3-butane diol, 1,6-hexane diol, 1,8-octane diol, neopentyl glycol, cyclohexane dimethanol, 2-methyl-1,3-propane diol, glycerine, trimethylol propane, 1,2,6-hexane triol, 1,2,4-butane triol, trimethylol ethane, pentaerythritol, quinitol, mannitol, sorbitol, methyl glycoside, diethylene glycol, triethylene glycol, tetraethylene glycol, dipropylene glycol, dibutylene glycol and the like.

When making an automotive headliner in accordance with the invention, the isocyanate-reactive compound is preferably a polyol or mixture of polyols that has an average of 2.0 to about 8, preferably from 3.8 to 8, hydroxyl groups/molecule and a hydroxyl equivalent weight of about 50 to about 500, preferably from about 100 to 170, more preferably from about 100 to about 135 and still more preferably from about 100 to 130. When a single polyol is used, it should by itself meet these hydroxyl equivalent weight and functionality parameters. If a mixture of polyols is used, the mixture as a whole should meet those parameters, although any individual polyol within the mixture may have a functionality and equivalent weight inside or outside of those ranges. Any water as may be present is not considered in determining the functionality or equivalent weight of the polyol or polyol mixture.

A more preferred average hydroxyl functionality for a polyol or polyol mixture used to produce an automotive headliner in accordance with this invention is from about 3.8 to about 6 hydroxyl groups/molecule. A still more preferred average hydroxyl functionality is from about 3.8 to about 5 hydroxyl groups/molecule. An especially preferred average hydroxyl equivalent weight is from about 110 to about 130.

The hydroxyl groups in the polyol or polyol mixture for making automotive headliners preferably are mostly secondary hydroxyl groups. Suitably at least 70%, at least 80% or at least 90% of the hydroxyl groups are secondary hydroxyl groups, and up to as much as 100% of the hydroxyl groups can be secondary hydroxyl groups. The polyol or polyol mixture is preferably substantially devoid of primary and secondary amino groups, as the present of these groups tends to make the polyurethane-forming composition too reactive to process easily. “Substantially devoid” in this context means that the material under consideration contains no more than trace quantities of such groups, as may be present as impurities. The polyol or polyol mixture for making automotive headliners may contain tertiary amino groups.

Preferred polyols which can be used alone (i.e., is the sole polyol) to make automotive headliners in accordance with the invention are poly(propylene oxide) polyols, having a functionality of 3.8 to 5.0 hydroxyl groups/molecule and a hydroxyl equivalent weight of from 100 to 170, more preferably from 110 to 130. These are preferably made using a polyol initiator compound. Examples of these are Voranol® 490 polyol and Voranol® 446 polyol, both available from Dow Chemical. These polyols can be used as part of a mixture of one or more additional polyols, provided that the mixture has the average functionality and equivalent weights described before.

Preferred polyols that can be used in polyol mixtures for making automotive headliners include those mentioned immediately above, as well as polyols having somewhat higher or lower functionalities and equivalent weights (provided again that the polyol mixture has the average functionality and equivalent weight described before). In addition, amine-initiated polyols may be used as a component in a polyol mixture. Examples of polyols that can be used in polyol mixtures include Voranol® 490 and Voranol® 446 polyols, described above; alcohol-initiated polyols having a functionality of from 2 to about 8, especially from 3.8 to 5 and a hydroxyl equivalent weight of 131-250, especially from 131-175, such as Voranol® 360 polyol (available from Dow Chemical), and amine-initiated polyols having an equivalent weight of from about 65 to about 250, especially from 70 to about 175, such as Voranol® 800 polyol (ethylene diamine-initiated polyol available from Dow Chemical) or Voranol® 391 polyol (o-toluene diamine-initiated polyol available from Dow Chemical).

Useful polyisocyanates include those having an average of 1.8 or more isocyanate groups per molecule. The isocyanate functionality is preferably from about 1.9 to 4, and more preferably from 1.9 to 3.5 and especially from 2.0 to 3.0. Suitable polyisocyanates include aromatic, aliphatic and cycloaliphatic polyisocyanates. Exemplary polyisocyanates include, for example, m-phenylene diisocyanate, 2,4- and/or 2,6-toluene diisocyanate (TDI), the various isomers of diphenylmethanediisocyanate (MDI), hexamethylene-1,6-diisocyanate, tetramethylene-1,4-diisocyanate, cyclohexane-1,4-diisocyanate, hexahydrotoluene diisocyanate, hydrogenated MDI (H₁₂ MDI), naphthylene-1,5-diisocyanate, methoxyphenyl-2,4-diisocyanate, 4,4′-biphenylene diisocyanate, 3,3′-dimethoxy-4,4′-biphenyl diisocyanate, 3,3′-dimethyldiphenylmethane-4,4′-diisocyanate, 4,4′,4″-triphenylmethane triisocyanate, polymethylene polyphenylisocyanates, so-called polymeric MDI products (or PMDI, i.e., mixtures of polymethylene polyphenylisocyanates with MDI), hydrogenated polymethylene polyphenylisocyanates, toluene-2,4,6-triisocyanate, and 4,4′-dimethyl diphenylmethane-2,2′,5,5′-tetraisocyanate.

A blowing agent may be present when it is desirable to produce a cellular product. Water is a preferred blowing agent. If used, water conveniently is used in an amount within the range of 3.0 to 5.5 parts by weight per 100 parts by weight of polyol(s). A preferred range is from about 3.5 to about 4.5 parts of water per 100 parts by weight polyol. The polyurethane-forming composition may include a physical blowing agent, in addition to or instead of the water, but this is generally less preferred. Such physical blowing agents include hydrocarbons, fluorocarbons, hydrofluorocarbons, chlorocarbons, chlorofluorocarbons and hydrochlorofluorocarbons. It is most preferred to exclude a blowing agent from the polyurethane-forming composition when making a composite in accordance with this invention, and in particular an automotive headliner.

The polyisocyanate and isocyanate-reactive components can be reacted at an isocyanate index of from 70 to 500 or more, although a more typical isocyanate index is from 80 to 130. Isocyanate index is calculated as the number of reactive isocyanate groups provided by the polyisocyanate component divided by the number of isocyanate-reactive groups in the polyurethane-forming composition (including isocyanate-reactive blowing agents such as water, if present) and multiplying by 100. Water is considered to have two isocyanate-reactive groups per molecule for purposes of calculating isocyanate index. A preferred isocyanate index is from 100 to 125.

The catalyst mixture is used in catalytically sufficient amounts. A suitable amount of the catalyst mixture is from about 0.02 to about 2 parts, especially from about 0.05 to about 0.5 part, of the catalyst mixture per 100 parts by weight of the polyol(s). The weight of any solvent or carrier is disregarded in determining the amount of catalyst mixture.

The polyurethane-forming composition may contain at least one surfactant, which is preferred when a cellular polyurethane is formed. The surfactant helps to stabilize the cells of the composition as gas evolves to form bubbles and expand the foam. Organosilicone surfactants are generally preferred types. A wide variety of these organosilicone surfactants are commercially available, including those sold by Goldschmidt under the Tegostab® name (such as Tegostab B-8462, B8427, B8433 and B-8404 surfactants), as well as various surfactant products commercially available from Air Products and Chemicals, such as DC-193, DC-198, DC-5000, DC-5043 and DC-5098 surfactants.

In addition to the foregoing ingredients, the polyurethane-forming composition may include various auxiliary components, such as fillers, colorants, odor masks, flame retardants, biocides, antioxidants, UV stabilizers, antistatic agents, viscosity modifiers, and the like.

Examples of suitable flame retardants include phosphorus compounds, halogen-containing compounds and melamine.

Examples of fillers and pigments include calcium carbonate, titanium dioxide, iron oxide, chromium oxide, azo/diazo dyes, phthalocyanines, dioxazines and carbon black.

Examples of UV stabilizers include hydroxybenzotriazoles, zinc dibutyl thiocarbamate, 2,6-ditertiarybutyl catechol, hydroxybenzophenones, hindered amines and phosphites.

Except for fillers, the foregoing additives are generally used in small amounts, such as from 0.01 percent to 3 percent each by weight of the polyurethane formulation. Fillers may be used in quantities as high as 50% by weight of the polyurethane formulation.

A viscosity modifier may be used in either the polyol or isocyanate components if needed or desired to bring the viscosity of that component into a particular range. A viscosity modifier will be used most commonly in cases in which the polyol is viscous relative to the polyisocyanate. In such a case, a viscosity modifier can be added to more closely match the viscosity of the polyol component with that of the polyisocyanate. The viscosity modifier preferably is not reactive with the polyol, water or polyisocyanate, although it may perform other functions (such as providing flame retardancy). It is generally preferred, for some applications such as producing fiber-reinforced polyurethanes, to use components that have a viscosity of 1500 cps or less at 25° C., and in such a case, a viscosity modifier may be blended with one or more of the components in order to bring the viscosity down into that range.

A fiber-reinforced polyurethane can be prepared according to the invention by

a) applying a polyurethane-forming composition that includes a polyol or mixture of polyols, an organic polyisocyanate, and a catalyst, wherein the catalyst is a mixture of a 1,2,4-triazole-blocked 1,8-diazabicyclo-5.4.0-undecene-7 and a phthalic acid-blocked 1,8-diazabicyclo-5.4.0-undecene-7 in a weight ratio of from 5:95 to about 30:70 to at least one reinforcing fiber to form an impregnated, reinforced mat, and

b) molding the impregnated, reinforced mat at an elevated temperature sufficient to cure the polyurethane-forming composition, to form a molded, fiber-reinforced polyurethane. Such a process is described, for example, in WO 07/015,1652, for making reinforced polyurethanes for applications such as automotive headliners.

The impregnated, reinforced mat can be prepared in various ways. One suitable approach for doing this is described in WO 07/015,1652. In that process, the polyurethane-forming composition is most conveniently applied to a fiber mat in a continuous fashion. The fiber mat can be supplied as a rolled good, which can be fed via a series of rollers, a moving belt, a tenter frame or other suitable apparatus to a station at which the polyurethane-forming composition is applied to it. The manner of applying the polyurethane-forming composition is not particularly critical, provided that the composition achieves good penetration into the fiber mat and in particular between the fibers of the mat. Spraying is a preferred method of applying the polyurethane-forming composition onto a fiber mat.

In another approach, the impregnated, reinforced mat is made by

a-1) impregnating a cellular polymer with the foamable polyurethane composition,

a-2) applying a reinforcing fiber to at least one side of the impregnated cellular polymer to form the impregnated, reinforced mat. In this approach, the reinforcing fiber may be supplied in the form of a previously prepared fiber mat, which may be a rolled good which can be applied to one or both surfaces of the impregnated cellular polymer via a series of rollers, a moving belt, a tenter frame or other suitable apparatus. Alternatively (or in addition), the reinforcing fiber may be applied in the form of chopped or other short-length fibers (up to 12 inches (30 cm), preferably up to 4 inches (10 cm) in length), which are sprayed or otherwise distributed across the surface of the impregnated cellular polymer. The liquid polyurethane-forming composition is generally tacky enough to temporarily adhere the fibers to the cellular polymer until the molding step is completed. The cellular polymer is preferably a flexible polyurethane foam. The cellular polymer preferably contains a large proportion (at least 50% by number) of open cells.

Additional, optional layers may be applied prior to the molding step if desired. For example, a reinforcing scrim or other reinforcing layer may be applied to either or both sides of the impregnated, reinforced mat. Various types of film layers may be applied, again to either or both sides of the impregnated, reinforced mat.

An adhesive film is one of particular interest as an additional layer that may be applied before the molding step. The adhesive film is suitably made from a thermoplastic organic polymer that has a melting temperature in the range of from 80° C. to 200° C., especially from 110 to 160° C., and above the maximum temperature encountered in the molding step. Adhesive films having these melting characteristics can be applied to the assembly prior to or simultaneously with the molding step, to form an assembly having a meltable film on at least one surface. In this manner, the adhesive film conforms to the exterior contours of at least that part of the surface of the assembly which is to be laminated to a show surface or other material in a subsequent step. Typically, the adhesive film becomes bonded to the rest of the assembly though the cured polyurethane.

The adhesive film may itself include reinforcing materials, particularly reinforcing fibers of the type described above.

A particularly suitable adhesive film has a thickness of about 1 to about 5 mm, especially about 2 to about 3 mm, and includes from 20 to 80, especially from 30 to 50, grams of reinforcing fibers, especially glass fibers, per square meter.

These optional layers are most conveniently applying by providing the layer material in the form of a rollstock which is fed continuously into the manufacturing process. These optional layers may be applied simultaneously with, before, or after the application of the polyurethane-forming composition to the fibers. Coverstocks may be applied to the impregnated, reinforced mat in the mold.

Apparatus and processing steps as illustrated in FIGS. 3 and 4 of WO 2002/04252 are readily adapted for producing the impregnated, reinforced mat, although the product described in WO 2002/04252 includes exterior reinforcing layers that are only optional to (but preferred in) this invention.

In some embodiments, the polyurethane-forming composition is prepared by bringing the various components together immediately prior to applying the composition to the fibers to form the impregnated, reinforced mat. Many of the ingredients may be blended together beforehand, provided that no isocyanate-reactive materials are blended with the polyisocyanate until just prior to application. For example, polyol, catalysts, water and surfactant may be combined beforehand to create a formulated polyol component which is then mixed with the polyisocyanate and applied to the fibers. Mixing of the components with the polyisocyanate is conveniently done using equipment such as impingement mixers, static mixers and other mixing devices. The preferred method of application to a mat of fibers is spraying. Equipment for mixing and spraying a polyurethane-forming composition is available from Admiral Equipment Company. Mixing is preferably performed at a temperature of less than 50° C., such as from 0 to 35° C. or from 0 to 25° C., to help prevent premature reaction before the impregnated, reinforced mat can be transferred to the mold.

The polyurethane-forming composition is generally applied to the fibers while at approximately room temperature (e.g., 15-30° C.), a slightly elevated temperature (up to about 40° C.) or a slightly reduced temperature (e.g. 0-15° C.). The fibers are conveniently at a temperature of from 0-40° C. when the polyurethane-forming composition is applied. Preheating the components and/or the fibers (or cellular polymer if used) to higher temperatures before applying the polyurethane-forming composition tends to accelerate the curing reaction more than is desired.

The impregnated, reinforced mat (and other optional layers, if any) is placed into a mold, in which the polyurethane-forming composition is cured and the assembly is formed into a desired shape. A cutting step or trimming step may take place before the molding step. This is necessary in processes in which the impregnated, reinforced mat is made continuously, as in that case it is necessary to cut the mat to length before insertion into the mold. The molding step preferably is performed as soon as possible after forming the impregnated, reinforced mat, so that curing of the composition occurs mainly within the mold. The time from when the polyurethane-forming composition is applied until the time that the mold is closed is preferably no greater than 30 seconds, more preferably from 1 to 25 seconds, and even more preferably from 5 to 20 seconds.

However, real-life manufacturing conditions, such as the unavailability of a prepared mold or production delays, sometimes interpose some delay between the time the impregnated, reinforced mat is prepared and when the molding step can take place. These delays may be as long as 10 minutes in some production facilities. During this time, the impregnated, reinforced mat is usually subjected to ambient temperatures that may be as high as about 40° C. An advantage of this invention is that the polyurethane-forming composition reacts slowly under these conditions, so that the impregnated, reinforced mat can still be molded easily after such delays to form products that are of good quality in terms of both their physical properties as well as aesthetically.

The mold suitably includes a lower forming tool or die, over which the impregnated, reinforced mat is positioned, together with any optional layers that have been added to the assembly at this point of the process. An upper forming tool or die is then closed over the impregnated mat. The forming tools together define an interior space that conforms to the desired shape and dimensions of the resulting fiber-reinforced polyurethane. During the curing step, sufficient pressure is applied to the mold to keep it closed as the polyurethane-forming composition cures. A mold release agent or other means for preventing the polyurethane from adhering to the interior surfaces of the mold may be applied prior to inserting the impregnated, reinforced mat.

The polyurethane-forming composition cures within the mold to form a polyurethane that encompasses the fibers. To promote the cure, the mold is preferably brought to an elevated temperature. The mold temperature is suitably in the range of from 35 to 80° C., and is preferably in the range of from 60 to 75° C. An especially preferred temperature range is from 70 to 75° C. When an optional adhesive polymer film layer is present, the curing temperature is further selected in combination with the melting temperature of the adhesive film layer, keep the adhesive film layer from melting during the molding process. The adhesive film layer may become softened enough to be shaped during the molding step.

In certain embodiments, the molded, fiber-reinforced polyurethane so made is laminated to one or more additional layers of material after it is demolded. Of particular interest for headliner applications are various types of show surfaces, which may be, for example, a woven or nonwoven fabric, a polymer film or sheet (such as a vinyl sheet), or natural or synthetic leather. The show surface is often backed with a thin layer of a polymeric foam in order to provide a softer cushion and appearance.

The lamination of the fiber-reinforced polyurethane to the additional layer or layers can be performed, for example, by gluing or through a heat-lamination process. This invention has particular applicability for making composites that undergo subsequent processing involving exposure to an elevated temperature of 125° to 200° C., in that the composite may be exposed to such temperatures without undergoing undesirable expansion or distortion, only a short time after being demolded. Typically, the post-demold aging time that is required before the composite is subjected to such temperatures is no greater than one hour, and is usually 30 minutes or less or even 20 minutes or less. Thus, a process of particular interest is one in which the composite is subjected to a post-demold process in which it is exposed to processing temperatures in the range of 125-200° C., especially 140-175° C., within a period from about 10 minutes to about one hour, especially from 10 minutes to 30 minutes, and most preferably from about 10 minutes to 20 minutes, after being demolded.

A heat-lamination process, and especially one in which the fiber-reinforced polyurethane is laminated to a show surface, is conveniently conducted by bringing the fiber-reinforced polyurethane and the additional layer into contact and exposing them to the aforementioned temperatures, usually under slight pressure to ensure that the additional layer is placed into contact with the fiber-reinforced polyurethane and becomes securely adhered to the fiber-reinforced polyurethane. Pressure can be applied using conventional apparatus such as a double band laminator, a series of nip rollers and the like.

In an especially preferred process, the additional layer and the fiber-reinforced polyurethane are bonded together through an adhesive film as described before. As described before, this adhesive film is suitably applied to the fiber-reinforced polyurethane during the preceding molding step and so becomes conformed to the exterior contours of at least a portion of the fiber-reinforced polyurethane. In such a case, the adhesive film may form a barrier to the transfer of gasses into and out of the composite after it is demolded. These gasses may include, for example, carbon dioxide generated in the blowing reaction, residual reactants such as polyisocyanates, catalysts or polyol materials, reaction by-products, air (penetrating into the composite to replace escaping gasses, for example) and the like. In such a case, it is desirable to produce physical openings through the adhesive film to allow gasses to permeate into and out of the fiber-reinforced polyurethane, as this exchange of gasses tends to reduce the holding time that is needed before the lamination step can be performed. Thus, it is preferred to perforate or slit the adhesive film layer shortly after demolding.

A preferred fiber-reinforced polyurethane of the invention is manufactured in the form of a vehicle headliner, especially for an automobile or a truck.

Headliners made in accordance with the invention have external dimensions and are shaped to fit onto the ceiling of a passenger compartment of a vehicle. The headliner may incorporate various optional functional or aesthetic features. Supplemental reinforcing layers, such as a scrim or fiber mat as described in WO 2002/04252, may be applied during the step of forming the composite, as described therein. A decorative cover layer may be applied, as described for example in U.S. Pat. No. 6,204,209. Cut-outs for interior lights, mirrors, visors, switches, controls or other accessories may be provided, as may points of attachment for these and other types of accessories. The headliner may be shaped to include ribs (such as for providing head impact protection) or other support structures. Deformable flaps as described in U.S. Pat. No. 5,833,304 may be incorporated into the design.

Reinforcing fibers useful for preparing automotive headliners may be in the form of a mat of chopped or continuous fibers. The fibers are most conveniently fiberglass, but can be made of other materials such as high-melting polymers like polyamide (nylon) fibers; carbon fibers; natural fibers from a variety of vegetable sources such as sea weed, hemp, coconuts, wheat, corn and flax; metals; and the like. The fibers may be woven or otherwise forming into rovings. Instead, the fibers may be randomly oriented short fibers that are formed into a mat, optionally through the use of a binder material. The fiber mat is sufficiently porous to facilitate penetration of the polyurethane-forming composition, so that a highly uniform composite can be prepared. A suitable mat weight is from 30 to 160 g/m² (˜0.1 to 0.5 ounces/square foot), especially from 75-125 g/m² (˜0.25 to 0.4 ounces/square foot).

As mentioned, optional layers may be applied to automotive headliners during the molding step. Of particular interest are reinforcing scrims as described in WO 2002/04252, which may be applied to either or both sides of the fiber mat. Reinforcing scrims are suitably prepared from fibers of the types described before, and as before may be woven or nonwoven (or both). Reinforcing scrims of particular interest are made of an organic polymer such as a polyolefin or a polyester, or a natural fiber as described before. Such a scrim may also contain a quantity of glass fibers in addition to the organic polymer or natural fibers. The reinforcing scrim tends to be heavier, on a weight/unit area basis, than the mat of reinforcing fibers. As such, it tends to be less porous and less easily penetrated by the polyurethane-forming composition, although some penetration usually occurs. Even if little penetration occurs, the cured polyurethane functions as an adhesive to bind the scrim. The reinforcing scrims tend to have weights on the order of from 125 to 460 g/m² (˜0.4 to 1.5 ounce/square foot), more suitably from 150-310 g/m² (˜0.5 to 1.0 ounce/square foot).

A particularly preferred molded headliner assembly includes a layer of a fiber-reinforced polyurethane, a reinforcing scrim on at least one side of the layer of the fiber-reinforced polyurethane, and an adhesive film on at least one side of the assembly. The adhesive film may be attached directly to the layer of fiber-reinforced polyurethane-, or may be attached to an intermediate reinforcing scrim. The reinforcing scrim layer or layers may be partially or wholly impregnated with the polyurethane.

The following examples are provided to illustrate the invention but are not intended to limit the scope thereof. All parts and percentages are by weight unless otherwise indicated.

### EXAMPLE 1

Automotive headliners are produced on a commercial scale production line. A “jelly roll” is assembled continuously on a production line by laying down, in order, a non-woven scrim layer, an adhesive film layer, chopped glass rovings, an open-celled polyurethane foam that is impregnated with a polyurethane-forming composition, more chopped glass rovings, a second adhesive layer and a bilaminate cover. The open-cell polyurethane foam is impregnated with the polyurethane-forming composition immediately prior to being laid down. The resulting jelly roll is then cut to length and the resulting pieces are stacked on a shuttle, where they are held for 5-10 minutes at ambient temperature prior to being introduced into a press mold which is heated to 70° C. The in-mold residence time that is needed to cure the polyurethane-forming composition is varied to determine the minimum time needed in the mold before the part can be demolded. After demolding, the part is washed and trimmed to produce a finished headliner.

The polyurethane-forming composition is a two-part formulation which include a polyol side and an isocyanate side. The polyol side includes a 99 parts by weight sucrose/glycerine-initiated poly(propylene oxide) having a hydroxyl equivalent weight of about 156 and a functionality of 4.1 hydroxyl groups/molecule, which is sold as Voranol™ 360 by Dow Chemical, and 1 part by weight of a 20/80 mixture of Toyocat DB 30 catalyst (a 1,2,4-triazole-blocked 1,8-diazabicyclo-5.4.0-undecene-7) and Toyocat DB60 catalyst (a phthalic acid-blocked 1,8-diazabicyclo-5.4.0-undecene-7). The polyol side contains about 0.436 parts of active catalysts per 100 parts of polyol. The isocyanate side is a polymeric MDI having an isocyanate equivalent weight of 134. The polyol and isocyanate sides are maintained separately at ambient temperature until they are mixed, again at ambient temperature and applied to the polyurethane foam. The isocyanate index is varied from 90 to 110.

The jelly roll remains pliant and easily moldable, even when the ambient temperature is high as 35-40° C. Demold time is only two minutes, and good quality parts that have few defects are obtained.

When the catalyst mixture is replaced with an amine-blocked organotin catalyst, demold time is over four minutes under these conditions. In addition, the jelly roll begins to cure prematurely when the ambient temperature approaches 35-40° C., making it difficult to mold the parts, leading to a significant amount of waste.

### EXAMPLE 2

Automotive headliners are made in a process similar to that described in Example 1, with the following variations. In this example, the catalyst mixture (again an 20/80 mixture of Toyocat DB 30 and Toyocat DB60 catalysts) is formed into a 10% by weight catalyst stream by diluting 10 parts of the catalyst mixture into 90 parts of Voranol™ 360 polyol. The polyol side is a sucrose/glycerine-initiated poly(propylene oxide) having a hydroxyl equivalent weight of about 126 and a functionality of 4.5 hydroxyl groups/molecule, which is sold as Voranol™ 446 by Dow Chemical. The polyol side, isocyanate side and catalyst stream are maintained separately at ambient temperature until they are mixed, again at ambient temperature and applied to the polyurethane foam. The ratio of the polyol side to catalyst stream is 99.33:1.67 by weight. About 0.07 grams of active catalyst are present per 100 grams of polyol. The isocyanate index is varied from 90 to 110.

The jelly roll in this case again remains pliant and easily moldable, even when the ambient temperature is high as 35-40° C. Demold time is again only two minutes, and good quality parts that have few defects are obtained.

When the catalyst mixture is replaced with an amine-blocked organotin catalyst, demold time is four to five minutes under these conditions.

1. A polyurethane catalyst system comprising a mixture of a 1,2,4-triazole-blocked 1,8-diazabicyclo-5.4.0-undecene-7 and a phthalic acid-blocked 1,8-diazabicyclo-5.4.0-undecene-7 in a weight ratio of from 5:95 to about 30:70.

2. A process for preparing a polyurethane and/or polyurea polymer, comprising mixing at least one isocyanate-reactive compound with at least one organic polyisocyanate at a temperature of 40° C. or less, in the presence a mixture of a 1,2,4-triazole-blocked 1,8-diazabicyclo-5.4.0-undecene-7 and a phthalic acid-blocked 1,8-diazabicyclo-5.4.0-undecene-7 in a weight ratio of from 5:95 to about 30:70, and then heating the resulting mixture to a temperature of at least 60° C. to cure the mixture and form a polyurethane and/or polyurea polymer.

3. A process for preparing a fiber-reinforced polyurethane, comprising,
a) applying a polyurethane-forming composition to at least one reinforcing fiber to form an impregnated, reinforced mat, and
b) molding the impregnated, reinforced mat at an elevated temperature sufficient to cure the polyurethane-forming composition, to form a molded, fiber-reinforced polyurethane,
wherein the polyurethane composition includes a polyol or mixture of polyols, an organic polyisocyanate, and a catalyst, wherein the catalyst is a mixture of a 1,2,4-triazole-blocked 1,8-diazabicyclo-5.4.0-undecene-7 and a phthalic acid-blocked 1,8-diazabicyclo-5.4.0-undecene-7 in a weight ratio of from 5:95 to about 30:70.

4. The process of claim 3 wherein in step a) the reinforcing fiber is formed into a mat to which the polyurethane-forming composition is applied.

5. The process of claim 4 wherein the polyurethane-forming composition is sprayed onto the mat of reinforcing fibers.

6. The process of claim 3 wherein, prior to step b), at least one additional layer is applied to the impregnated, reinforced mat.

7. The process of claim 6, wherein said additional layer is an adhesive film.

8. The process of claim 3, wherein after step b), the molded, fiber-reinforced polyurethane is laminated to at least one additional layer.

9. The process of claim 3, wherein the polyurethane-forming composition contains no catalyst in addition to the mixture of 1,2,4-triazole-blocked 1,8-diazabicyclo-5.4.0-undecene-7 and phthalic acid-blocked 1,8-diazabicyclo-5.4.0-undecene-7.

10. The process of claim 3, wherein step a) is performed by
a-1) impregnating a cellular polymer with the foamable polyurethane composition,
a-2) applying a reinforcing fiber to at least one side of the impregnated cellular polymer to form the impregnated, reinforced mat.

11. The process of claim 3, wherein the molded, fiber-reinforced polyurethane forms all or part of an automotive headliner.

12. The process of claim 11 wherein the polyol or polyol mixture has an average hydroxyl functionality from about 3.8 to about 5 hydroxyl groups/molecule.

13. The process of claim 12 wherein the polyol or polyol mixture has an average hydroxyl equivalent weight is from about 110 to about 130.

14. The process of claim 13 wherein at least 80% of the hydroxyl groups in the polyol or polyol mixture are secondary hydroxyl groups.

15. The process of claim 3 wherein the polyurethane-forming composition contains from 0.02 to 2 parts of the catalyst mixture per 100 parts by weight of the polyol or mixture of polyols.

16. The process of claim 3 wherein the polyurethane-forming composition contains from 0.05 to 0.5 part of the catalyst mixture per 100 parts by weight of the polyol or mixture of polyols.
